(19) United States
(12) Patent Application Publication
(10) Pub. No.: US 2013/0001933 A1
(43) Pub. Date: Jan. 3, 2013

(54) OCCUPANT PROTECTION APPARATUS FOR VEHICLE

(75) Inventors: Junichi UMEHARA, Fujinomiya-shi (JP); Hiroyuki IWAMOTO, Fujinomiya-shi (JP)

(73) Assignee: NIHON PLAST CO., LTD., Fujinomiya-shi (JP)

(21) Appl. No.: 13/534,108

(22) Filed: Jun. 27, 2012

(30) Foreign Application Priority Data
Jun. 28, 2011 (JP) 2011-143038

(51) Int. Cl. B60R 21/233; B60R 21/213; B60R 21/207; B60R 21/232

(52) U.S. Cl. 280/730.2

(57) ABSTRACT

An occupant protection apparatus for a vehicle includes a curtain airbag device and a side airbag device. The vehicle includes a side window glass for closing from a vehicle body upper construction to a waist line of the vehicle. The curtain airbag device includes a curtain airbag and is installed at the vehicle body upper construction. The side airbag device includes a side airbag stowed at a lower level than the waist line and installed in a seat of the vehicle. Upon a side impact to the vehicle, the curtain airbag is developed downward, and the side airbag is inserted into a space between the curtain airbag and the side window glass. According to the occupant protection apparatus, development, man-hours such as adjustments of gas amounts of inflators and a production cost can be decreased in spite of the installation of at least two types of airbags.

### BACKGROUND OF THE INVENTION

1. Field of the Invention

The present invention relates to an occupant protection apparatus for a vehicle for protecting an occupant's head upon aside impact to the vehicle.

2. Description of Related Art

As an occupant protection apparatus to a side impact, known are a curtain airbag installed at a roof side rail and a side airbag installed in a side of a seatback. Upon a side impact, each of a curtain airbag and a side airbag is inflated by gas injected from an inflator. Japanese Patent Application Laid-Open No. 2008-114631 (Patent Document 1) shows an occupant protection apparatus in which a lower end of a curtain airbag developed downward and an upper end of a developed side airbag are connected with each other by a hook-and-loop fastener.

### SUMMARY OF THE INVENTION

In the occupant protection apparatus disclosed in the above Patent Document 1, since the both airbags are dynamically connected by the hook-and-loop fastener during or after their developments, its development man-hours such as adjustments of gas amounts of the inflators and its production cost may increase.

An object of the present invention is to provide an occupant protection apparatus for a vehicle that includes at least two types of air bags but doesn't need adjustments of gas amounts of inflators, and can decrease its development man-hours and its production cost.

An aspect of the present invention provides an occupant protection for a vehicle that includes a curtain airbag device and a side airbag device, wherein the vehicle includes a side window glass for closing from a vehicle body upper construction to a waist line of the vehicle, the curtain airbag device includes a curtain airbag and is installed at the vehicle body upper construction, the side airbag device includes a side airbag stowed at a lower level than the waist line and installed in a seat of the vehicle, the curtain airbag is developed downward upon a side impact to the vehicle, and the side airbag developed upon the side impact is inserted into a space between the curtain airbag and the side window glass.

According to the aspect, upon a side impact (developing [inflating] of the airbags), the curtain airbag and the side airbag lap at a higher level than the waist line, and the side airbag is inserted into the space between the curtain airbag developed downward and the side window glass, so that development man-hours such as adjustments of gas amounts of inflators and a production cost can be decreased in spite of the installation of at least two types of airbags.

### BRIEF DESCRIPTION OF THE DRAWINGS

FIG. 1 is a side view showing a state where a curtain airbag and a side airbag in an occupant protection apparatus for a vehicle according to an embodiment are developed; and

FIG. 2 is a cross-sectional view taken along a line II-II shown in FIG. 1.

### DETAILED DESCRIPTION OF THE EMBODIMENT

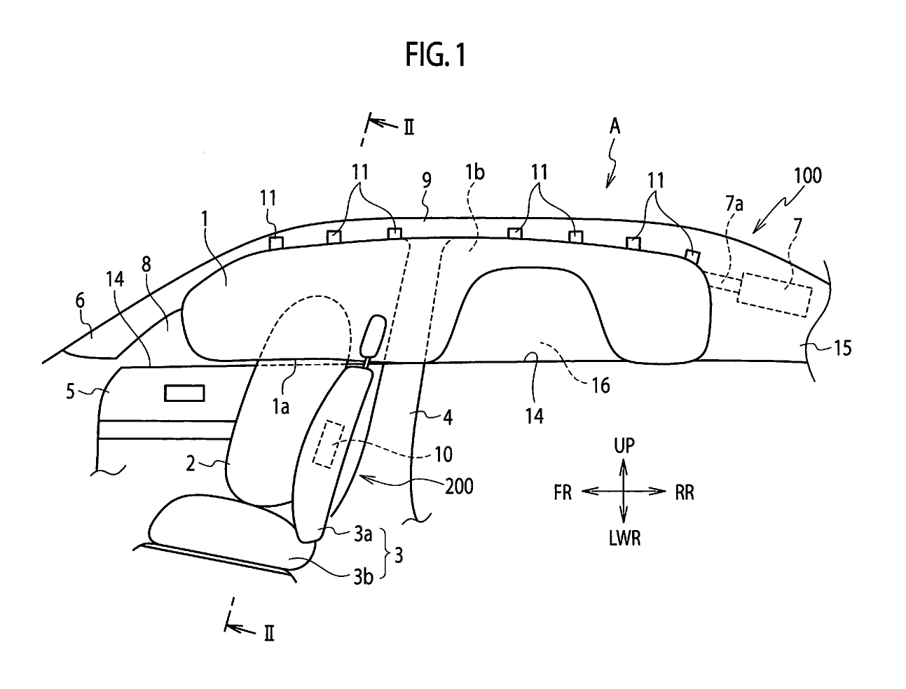

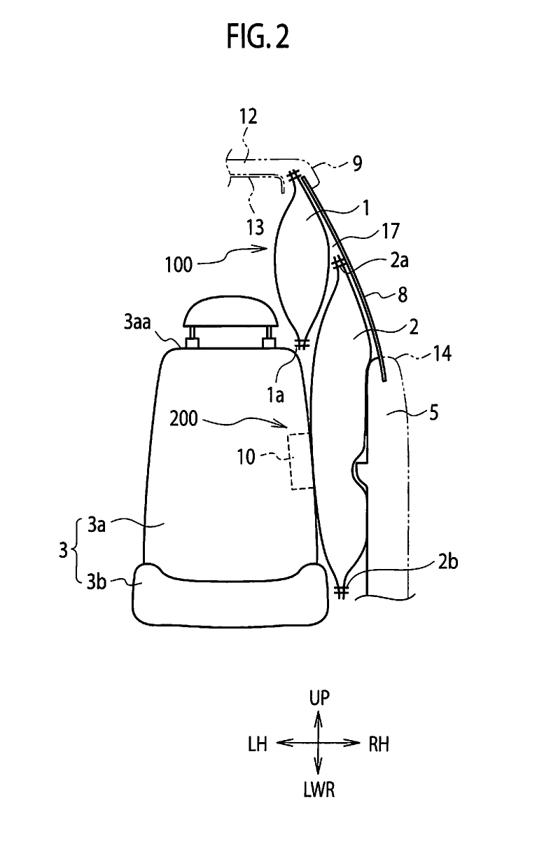

Hereinafter, an occupant protection apparatus according to an embodiment will be explained with reference to FIGS. 1 and 2. The occupant protection apparatus includes a curtain airbag device 100 and a side airbag device 200 that are explained later. FIGS. 1 and 2 shows a state where a curtain airbag 1 of the curtain airbag device 100 and a side airbag 2 of the side airbag device 200 are developed.

As shown in FIG. 1, a vehicle A in which the occupant protection apparatus according to the present embodiment includes an A-pillar (front pillar, 1st pillar) 6 arranged at a foremost position in a cabin, a B-pillar (center pillar, 2nd pillar) 4 arranged at an almost center of the cabin, and a C-pillar (rear pillar, 3rd pillar) 15 arranged at a rearmost position in the cabin. In addition, the vehicle A includes a side roof rail (vehicle body upper construction) that is extended in a front-back direction and connects upper ends of the pillars 6, 4 and 15. Note that FIG. 1 shows only a right side but a left side also includes an identical configuration symmetrically.

Further, the vehicle A includes a rear roof rail (not shown) that connects rear ends of the right and left side roof rails 9, a front roof rail (not shown) that connects front ends of the right and left side roof rails 9, a roof panel 12 (see FIG. 2) surrounded by these roof rails, a front side window glass(es) 8 and a front side door(s) 5. A lower end line(s) of the front side window glass 8, i.e. an upper end line of the front side door 5 (excluding its sash frame) is a waist line (belt line) 14.

A rear door (w/o a reference numeral) is provided on a rear side of the front side door 5, and a rear side window glass 16 is provided in the rear door. When the front side window glass 8 is elevated up so as to become appressed to a sealant of a sash (not shown), intrusion of rain and wind can be prevented. As shown in FIG. 2, a roof lining 13 is attached on a cabin-side of the roof panel 12.

The curtain airbag device 100 is installed along the side roof rail 9. The curtain airbag 1 of the curtain airbag device 100 is folded and stowed in a module of the curtain airbag device 100. The curtain airbag device 100 is covered by the roof lining 13 (or a roof rail garnish molding) so as to be hidden. The curtain airbag device 100 is also includes an inflator 7 that can generate gas for inflating the curtain airbag 1. The curtain airbag 1 has a gas introduction portion 7a at its rear end, and is connected with the inflator 7 via the gas introduction portion 7a.

Upon a side impact to the vehicle A, gas is supplied into an inside of the curtain airbag 1 from the inflator 7 via the gas introduction portion 7a, so that the curtain airbag 1 is inflated from its stowed state and breaks through the roof lining 13 to be developed downward as shown in FIGS. 1 and 2. The developed curtain airbag 1 is suspended from the side roof rail 9 via the support members 11. At this time, a lower end 1a of the curtain airbag 1 positions at a higher level than an uppermost portion 3aa (see FIG. 2) of a seatback 3a of a seat 3 in an ordinarily-reclined state. Note that the seat 3 includes the seatback 3a, a seat cushion 3b and a heat restraint.

The curtain airbag 1 develops downward so as to cover the front side window glass 8 and the rear side window glass 16. Note that a portion of the curtain airbag 1 that covers the rear side window glass 16 is partially cut away so that it can develop faster by reducing its inside volume, and only its portion beside an occupant on the rear seat inflates.

The side airbag device 200 is installed along a door-side side portion of the seatback 3a. The side airbag 2 of the side airbag device 200 is folded and stowed in a module of the side airbag device 200 at a lower position than the waist line 14. The side airbag device 200 is covered by a fabric of the seatback 3a so as to be hidden. The side airbag device 200 is also includes an inflator 10 that can generate gas for inflating the side airbag 2.

Upon a side impact to the vehicle A, gas is supplied into an inside of the side airbag 2 from the inflator 10, so that the side airbag 2 is inflated from its stowed state and breaks through the fabric of the seatback 3a to be developed laterally outward as shown in FIGS. 1 and 2. An upper end 2a of the developed side airbag 2 is inserted into a space 17 between the curtain airbag 1 and the front side window glass 8. In addition, a lower end 2b of the developed side airbag 2 reaches beside the seat cushion 3b.

As explained above, upon a side impact (developing [inflating] of the airbags), the curtain airbag 1 and the side airbag 2 lap at a higher level than the waist line 14, and the side airbag 2 is inserted into the space 17 between the curtain airbag 1 developed downward and the front side window glass 8, so that development man-hours such as adjustments of gas amounts of the inflators 1 and 10 and a production cost can be decreased in spite of the installation of at least two types of airbags 1 and 2.

In the above-mentioned occupant protection apparatus disclosed in the Patent Document 1, the curtain airbag and the side airbag are connected with each other by a hook-and-loop fastener. Here, their connection by a hook-and-loop fastener may need a pressing force to the hook-and-loop fastener and make the hook-and-loop fastener in terms of position and time. Therefore, it is needed to adjust internal pressures of the curtain airbag and the side airbag precisely, so that it is needed to adjust the gas amounts of the inflators precisely. This causes incrementation of the development man-hours and the production cost. According to the occupant protection apparatus in the present embodiment, the development man-hours and the production cost can be reduced, because it is not needed to physically connect the curtain airbag 1 and the side airbag 2 with each other.

In addition, the lower end 1a of the curtain airbag 1 is positioned at a higher level than the uppermost portion 3aa of the seatback 3a in a ordinarily-reclined state, the space 17 can be formed stably between the curtain airbag 1 and the front side window glass 8 and thereby the side airbag 2 can be inserted into the space 17.

In the above embodiment, the curtain airbag 1 that is stowed in the module before its development is supported by the side roof rail 9. However, the curtain airbag 1 may be supported by the roof panel 12, the pillars 6 to 15 or the (front and rear) side doors 5.

In addition, in the above embodiment, the inflator 10 for the side airbag 2 is disposed in the seatback 3a at a lower level than the waist line 14. However, the inflator 10 may be disposed in the seat cushion 3b.

Further, in the above embodiment, body type of the vehicle A is a 4-door sedan, but it may be other types such as 2-door coupe and 1-box, and, in these cases, the side airbag in its stowed state is stowed at a lower level than the waist line.

What is claimed is:

1. An occupant protection apparatus for a vehicle comprising:
a curtain airbag device; and
a side airbag device, wherein
the vehicle includes a side window glass for closing from a vehicle body upper construction to a waist line of the vehicle,
the curtain airbag device includes a curtain airbag and is installed at the vehicle body upper construction,
the side airbag device includes a side airbag stowed at a lower level than the waist line and installed in a seat of the vehicle,
the curtain airbag is developed downward upon a side impact to the vehicle, and
the side airbag developed upon the side impact is inserted into a space between the curtain airbag and the side window glass.

2. The occupant protection apparatus according to claim 1, wherein
the curtain airbag has a size so that a lower end thereof positions at a higher level than the waist line when developed, and
the side airbag has a size so that an upper end thereof positions at a higher level than the waist line when developed.
